(19) United States
(12) Patent Application Publication
(10) Pub. No.: US 2019/0316515 A1
(43) Pub. Date: Oct. 17, 2019

(54) FORCED EXHAUST SYSTEM FOR INCREASING ENGINE EFFICIENCY

(71) Applicant: Justin FREDERICK, Douglassville, PA (US)

(72) Inventor: Justin FREDERICK, Douglassville, PA (US)

(21) Appl. No.: 16/384,466

(22) Filed: Apr. 15, 2019

Related U.S. Application Data
(60) Provisional application No. 62/658,506, filed on Apr. 16, 2018.

(51) Int. Cl. F02B 33/40; F02B 39/10; F02B 39/04; F02B 37/00

(52) U.S. Cl. CPC F02B 33/40; F02B 37/00; F02B 39/04; F02B 39/10

(57) ABSTRACT

A forced exhaust system for increasing engine efficiency has an engine with at least one cylinder. The cylinder has a combustion chamber and a moveable piston. An intake port provides air/fuel/oil to the combustion chamber. An exhaust port is connected to the combustion chamber to remove exhaust gasses and uses an exhaust valve to control the exhaust timing. An exhaust device is connected to the exhaust port and lowers the pressure at the exhaust port which forcefully removes the products of combustion from the combustion chamber after ignition when the exhaust valve is open. By applying a vacuum to the exhaust port, the exhaust gases are removed quickly and utilizes more of the compression stroke than is possible in conventional engines. In this way, the user is able to control the intake and exhaust pressures independently in a two-stroke engine.

### CROSS REFERENCE TO RELATED APPLICATIONS

This application claims priority and herein incorporates by reference U.S. provisional patent application 62/658,506, filed Apr. 16, 2018.

### BACKGROUND OF THE INVENTION

The modern world owes a great deal of its progress to the invention and evolution of the internal combustion engine. It is hard to overestimate the role engines play in our everyday life living in the 21 century. Of course, there have been many improvements in engine technology leading to ever increasing efficiencies and even more usefulness.

While it is true that much has been done to improve engine efficiency, there is still a need for a simple, safe and cost efficient way to increase the performance of engines.

### SUMMARY OF THE INVENTION

A forced exhaust system for increasing engine efficiency has an engine with at least one cylinder. The cylinder has a combustion chamber and a moveable piston. An intake port provides air/fuel/oil to the combustion chamber. An exhaust port is connected to the combustion chamber to remove exhaust gasses and uses an exhaust valve to control the exhaust timing. An exhaust device is connected to the exhaust port and lowers the pressure at the exhaust port which forcefully removes the products of combustion from the combustion chamber after ignition when the exhaust valve is open. By applying a vacuum to the exhaust port, the exhaust gases are removed quickly and utilizes more of the compression stroke than is possible in conventional engines. In this way, the user is able to control the intake and exhaust pressures independently in a two-stroke engine.

Other features and advantages of the instant invention will become apparent from the following description of the invention which refers to the accompanying drawings.

### BRIEF DESCRIPTION OF THE DRAWINGS

FIG. 1 is an illustration of an engine having a forced exhaust device according to an embodiment of the present invention.

FIG. 2 is an illustration of an engine having a forced intake and exhaust device according to an embodiment of the present invention.

FIG. 3 is an illustration of an engine having a forced intake and exhaust device with a sliding exhaust valve according to an embodiment of the present invention.

FIG. 4 is an illustration of an engine having a forced intake and exhaust device with overhead valves according to an embodiment of the present invention.

FIG. 5 is an illustration of the engine shown in FIG. 4 with a fuel injector instead of a spark plug.

FIG. 6 is an illustration of an engine having two opposed pistons with a forced intake and exhaust device according to an embodiment of the present invention.

FIG. 7 is an illustration of the engine shown in FIG. 2 with a fuel injector

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

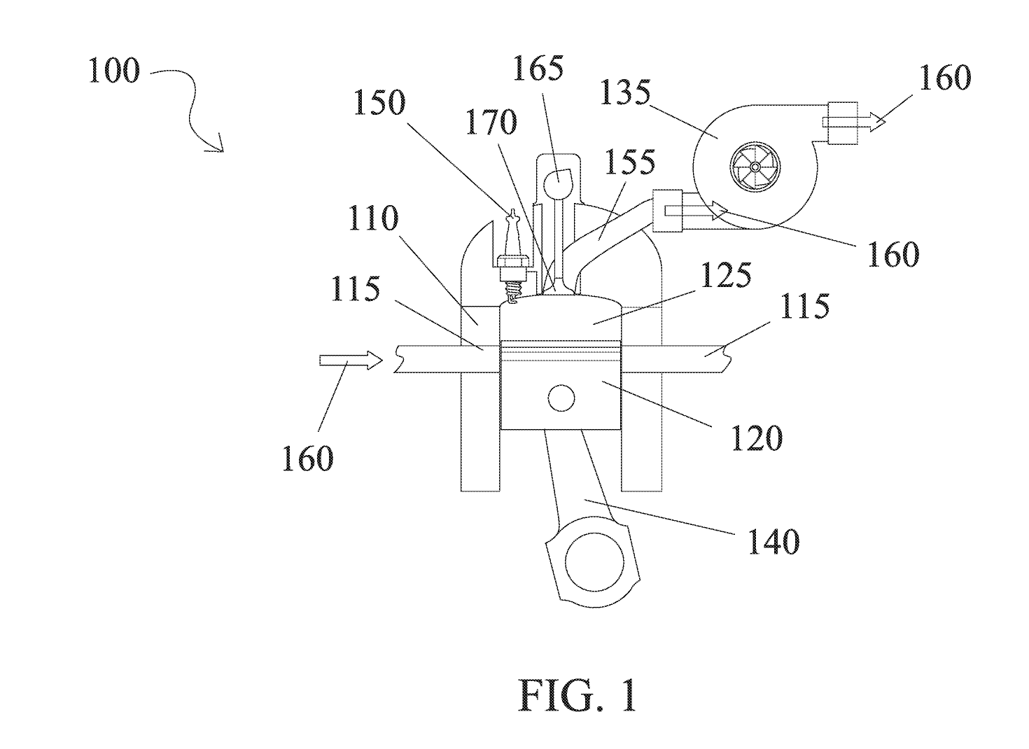

Referring to FIG. 1, a forced exhaust system for increasing engine efficiency 100 is shown having a cylinder 110 with a piston 120. An intake port 115 on each side of cylinder 110 is provided to introduce fuel/air/oil mixture into a combustion chamber 125. A flow direction 160 is shown to illustrate the overall flow pattern within cylinder 110. Piston 120 is connected to connecting rod 140 as is known in the art. An exhaust valve 170 is connected to a camshaft 165 to open and close exhaust valve 170. A spark plug 150 is provided to ignite the air/fuel/oil mixture in combustion chamber 125. A exhaust device 135 is connected to an exhaust port 155 to actively draw exhaust gases from combustion chamber 125 after ignition. In a typical two-stroke engine, exhaust gases are displaced by fresh fuel/air/oil mixture as the piston moves up in the cylinder during the compression stroke. This leads to inefficiencies such as limiting horsepower and compression. The instant invention overcomes these issues by forcefully withdrawing exhaust gases. The instant invention allows the user to control the intake pressure independently from the exhaust pressure in a two-stroke engine.

Exhaust device 135 is a pump or a blower that is operated through a connection to the engine. Other exhaust devices, such as but not limited to vacuum pumps, fans, superchargers, etc. are useable as long as the pressure is reduced at the exhaust port, thus providing a forced evacuation of the exhaust gases. A supercharger may be used as exhaust device 135 by connecting exhaust port 155 to the output of the supercharger. The connection to exhaust device 135 can be through a belt and pulley system, gear or chain as is known in the art. Of course other methods of activating exhaust device 135 may be used such as, but not limited to, mechanical linkage or electrically operated motor. In this way, exhaust gases are rapidly removed allowing exhaust valve 150 to be closed for more of the compression cycle than is possible in a conventional engine as well as efficiently removing more of the exhaust gases.

Exhaust device 135 may be continuously operated and controlled only by exhaust valve 150 or may be regulated by mechanical or electrical means to turn on and off at selected timing conditions correlating to the opening and closing of exhaust valve 150. Although only one exhaust valve is shown in the figures, it is understood that any number of exhaust valves may be used as is known in the art.

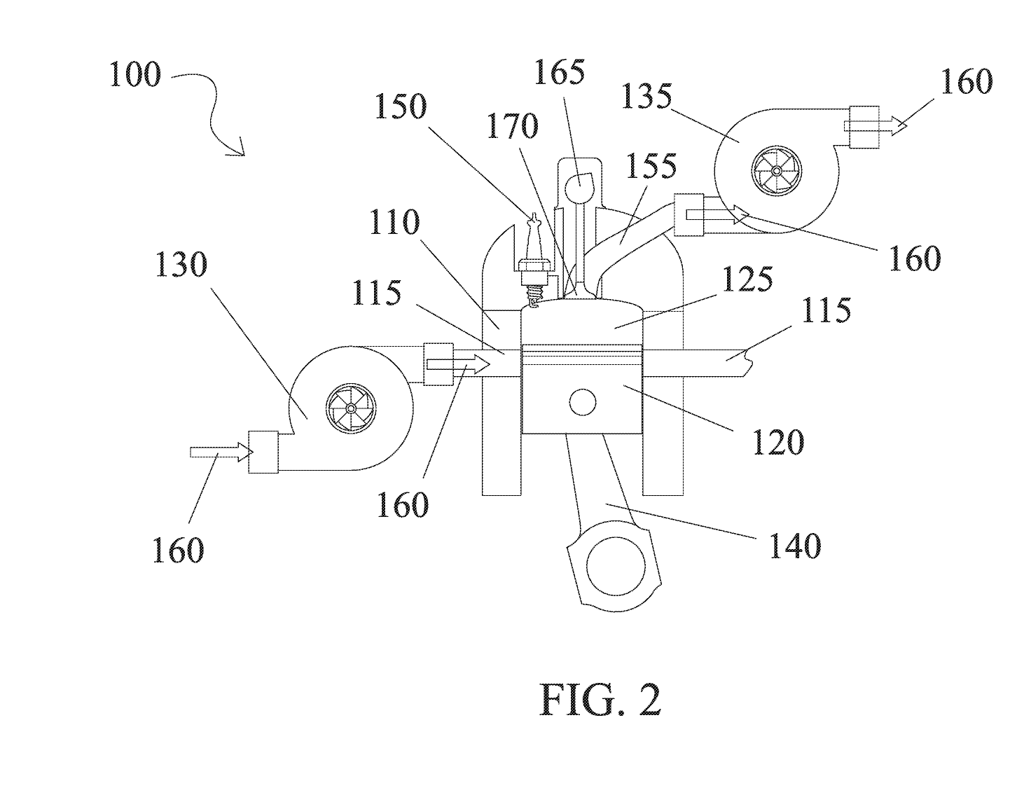

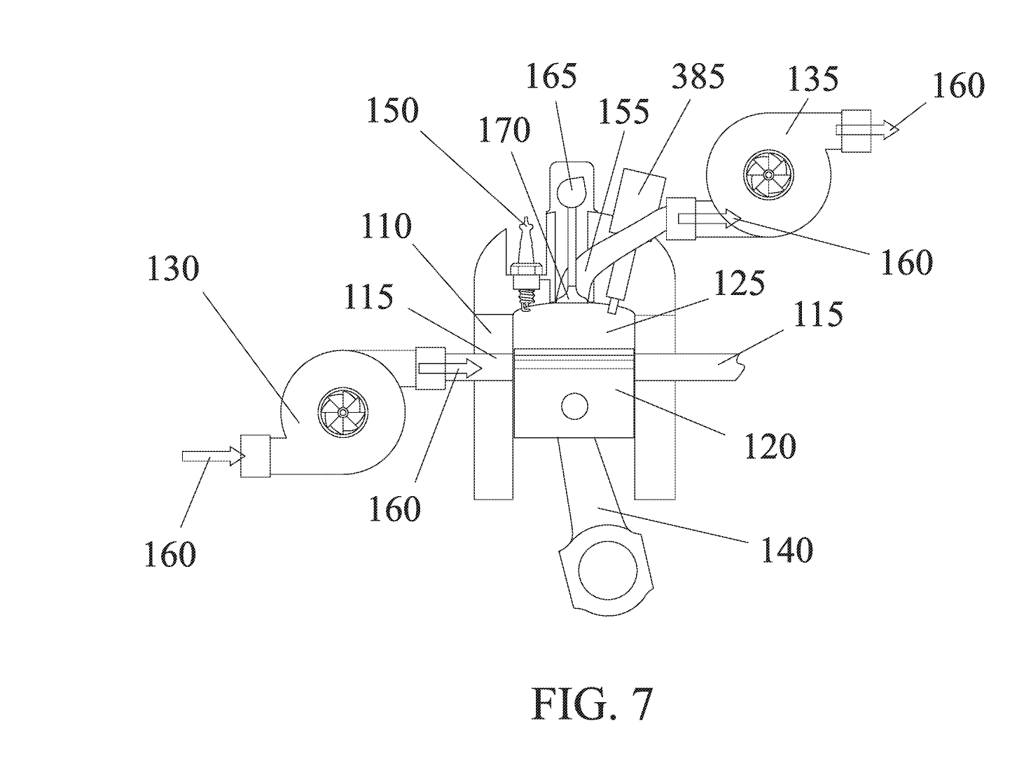

Referring now to FIGS. 2 and 7, an intake device 130 is added to further improve efficiency by controlling the intake pressure. Intake device 130 is pump or blower. Of course other devices may be used to control the intake pressure such as, but not limited to intake pumps or fuel injectors as is known in the art. Again, as discussed above, exhaust device 135 is used to reduce the pressure and to forcefully evacuate the exhaust gases from combustion chamber 125. As discussed above, this allows the user to control the intake pressure independently from the exhaust pressure in a two-stroke engine.

FIG. 7 is provided to illustrate a configuration using a fuel injector 385 and spark plug 150. In this embodiment, fuel is introduced through fuel injector 385 and air is introduced through intake port 115.

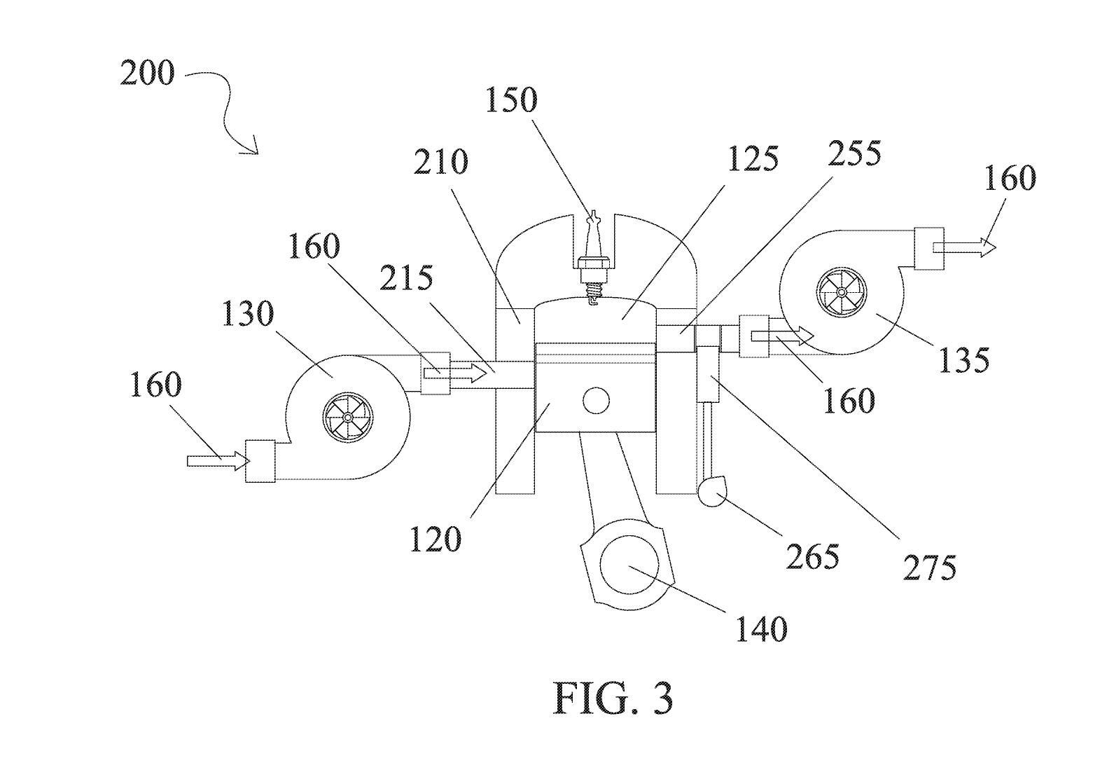

Now referring to FIG. 3, a forced exhaust system for increasing engine efficiency 200 is shown having a cylinder 210 with piston 120 connected to connecting rod 140. An intake port 215 is provided on one side of cylinder 210 and is pressurized using intake device 130. An exhaust port 255 is provided and is controlled by a sliding valve 275 connected to a camshaft 265. Again, as discussed above, exhaust device 135 is connected to exhaust port 255 to rapidly remove the exhaust gases from combustion chamber 125 after ignition.

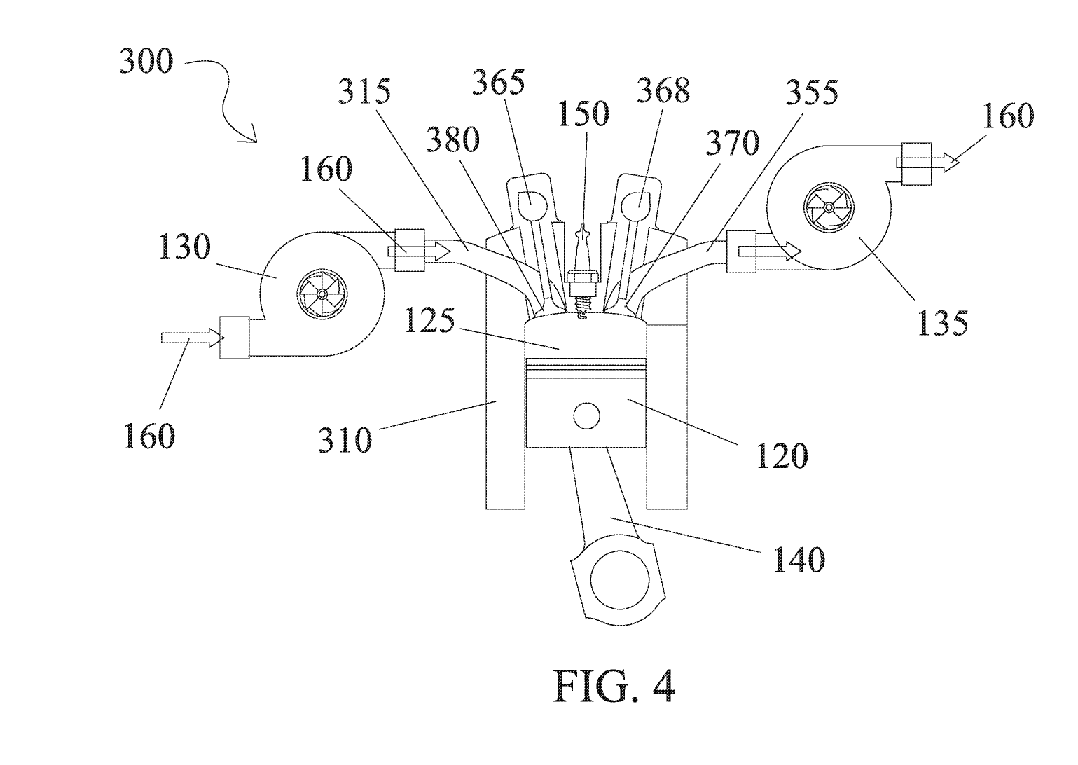

Referring to FIG. 4, a forced exhaust system for increasing engine efficiency 300 is shown having a cylinder 310 with overhead valves. An intake port 315 is provided to introduce air/fuel/oil mixture and an intake valve 380 is used to control the intake. An exhaust port 355 is provided to remove exhaust products after combustion and is controlled with an exhaust valve 370. A camshaft 365 is used to control the timing of intake valve 380 and a camshaft 368 is used to control the timing of exhaust valve 370 as is known in the art.

Again in this embodiment, intake device 130 is provided to pressurize the intake air/fuel/oil mixture and exhaust device 135 is provided to actively remove the exhaust gases in combustion chamber 125 after combustion. By applying a vacuum to exhaust port 355, the exhaust gases can be removed much more quickly than in prior art engines and therefore the instant engine can utilize much more of the compression part of the stroke to compress the air/fuel/oil mixture than is possible in conventional engines. By actively removing the exhaust gases, exhaust valve 368 can be closed much earlier thus adding to the efficiency of the power stroke. In this embodiment, spark plug 150 is utilized to provide ignition.

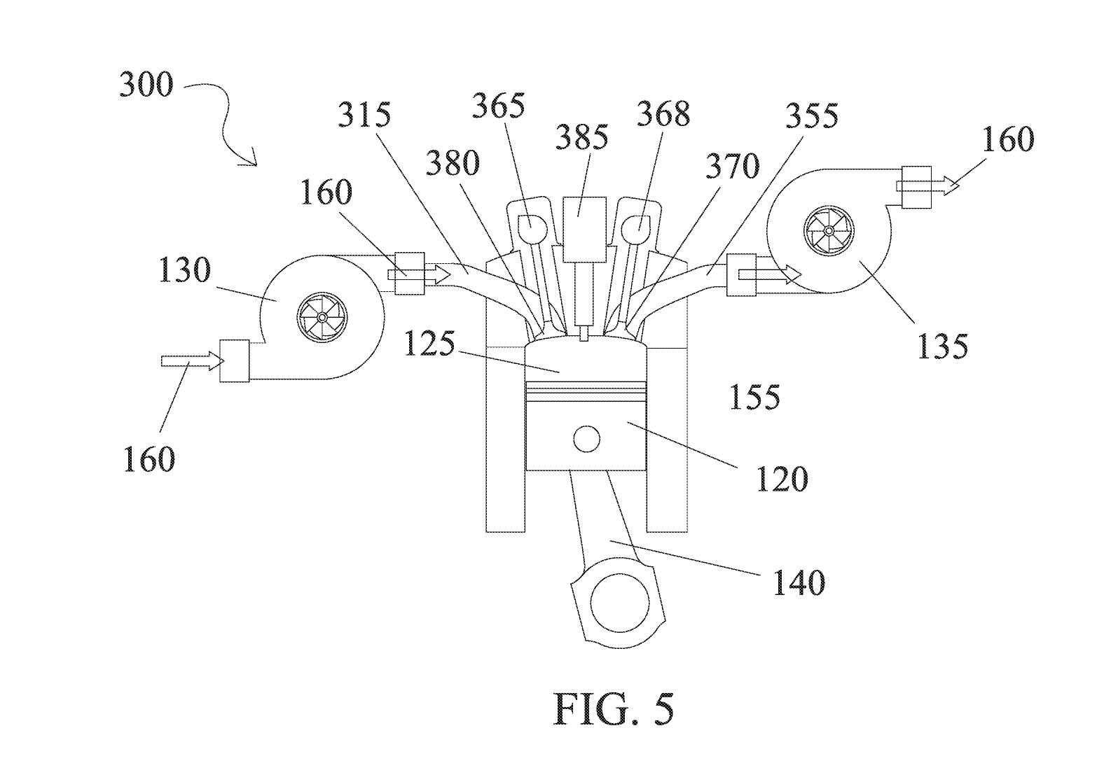

Now referring to FIG. 5, a fuel injector 385 is provided to supply fuel to combustion chamber 125. In the embodiment shown, no spark plug is used and is set up to operate as a diesel engine where compression provides ignition as is known in the art.

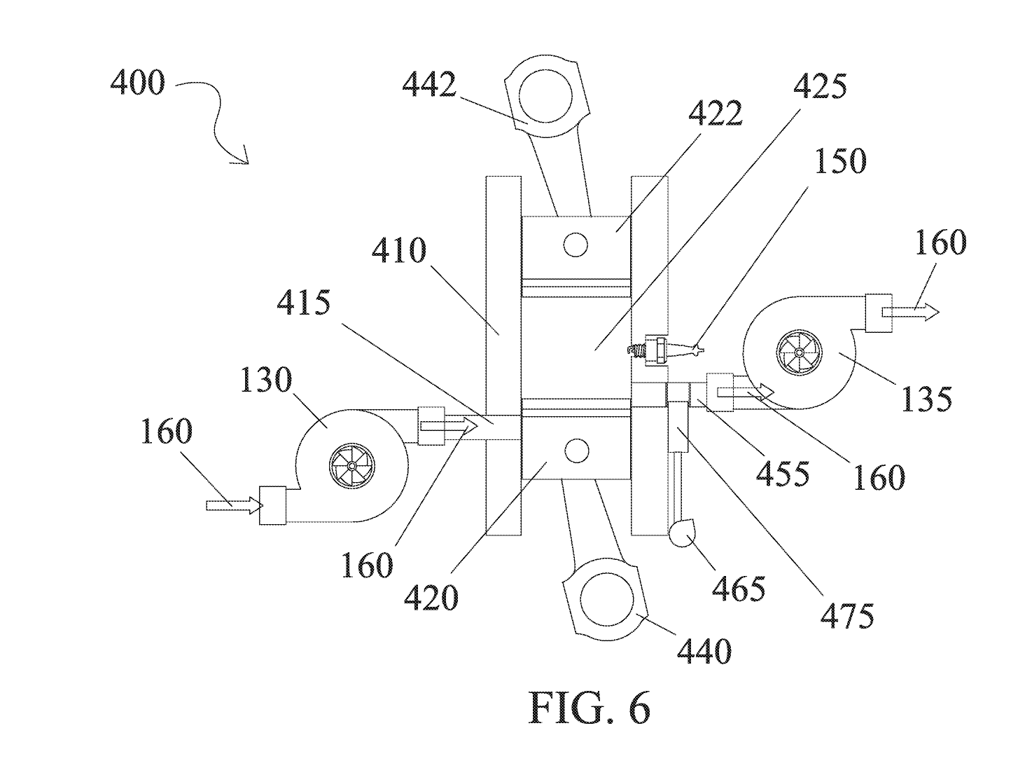

Referring now to FIG. 6, a forced exhaust system for increasing engine efficiency 400 is shown having a cylinder 410 with two opposing pistons 420 and 422 contained therein. Each piston, 420 and 422 respectively are connected to connecting rods 440 and 442. An intake port 415 is used to introduce air/fuel/oil mixture to a combustion chamber 425. In the embodiment shown, piston 420 controls intake by selectively covering intake port 415. Of course other methods may be used to control intake such as, but not limited to valves, fuel injectors, etc. as is known in the art. In the embodiment shown, a sliding exhaust valve 475 is used to selectively open and close an exhaust port 45. Of course other kinds of exhaust valves may be used.

Again, as discussed above, exhaust device 135 is connected to exhaust port 455 to rapidly remove the exhaust gases from combustion chamber 425 after ignition and thus increase the efficiency of the power stroke by increasing the utilization of the compression stroke to actually compress the air/fuel/oil mixture rather than utilizing some of the cycle to exhaust the gases.

It should be clear that any useable combination of valves, sparkplugs, fuel injectors, etc. may be used as is known in the art as long as an exhaust device is used to actively remove exhaust gases from the combustion chamber in order to increase the efficiency of the compression stroke by reducing the need for the compression stroke to force the exhaust gases out the exhaust port.

Although the instant invention has been described in relation to particular embodiments thereof, many other variations and modifications and other uses will become apparent to those skilled in the art.

What is claimed is:

1. A forced exhaust system for increasing engine efficiency comprising:
an engine;
said engine having at least one cylinder;
said art least one cylinder having a combustion chamber;
a piston moveably disposed within said at least one cylinder;
an intake port disposed within said at least one cylinder in mechanical communication with said combustion chamber;
an exhaust port;
said exhaust port in mechanical communication with said combustion chamber to remove exhaust gasses;
an exhaust valve disposed in said exhaust port; and
an exhaust device connected to said exhaust port whereby a pressure is reduced at said exhaust port whereby said exhaust gasses are forcefully removed from said combustion chamber after ignition when said exhaust valve is open.

2. The forced exhaust system for increasing engine efficiency according to claim 1 wherein said exhaust device is a blower device.

3. The forced exhaust system for increasing engine efficiency according to claim 1 wherein said exhaust device is a supercharger whereby said exhaust port is connected to intake end of said supercharger.

5. The forced exhaust system for increasing engine efficiency according to claim 1 wherein said exhaust device is a vacuum pump.

6. The forced exhaust system for increasing engine efficiency according to claim 1 further comprising an intake device connected to said intake port.

7. The forced exhaust system for increasing engine efficiency according to claim 6 wherein said intake device is a supercharger.

8. The forced exhaust system for increasing engine efficiency according to claim 1 wherein said exhaust valve is a sliding exhaust valve.

9. The forced exhaust system for increasing engine efficiency according to claim 1 wherein said engine is a two-stroke engine.

10. The forced exhaust system for increasing engine efficiency according to claim 1 wherein said engine is a gasoline engine.

11. The forced exhaust system for increasing engine efficiency according to claim 1 wherein said engine is a diesel engine.

12. The forced exhaust system for increasing engine efficiency according to claim 1 further comprising a second piston disposed within said at least one cylinder wherein said piston and said second piston oppose each other and share said combustion chamber.

13. The forced exhaust system for increasing engine efficiency according to claim 1 wherein said exhaust device is powered by an electric motor.

14. The forced exhaust system for increasing engine efficiency according to claim 1 wherein said exhaust device is powered by said engine.
